(19) United States
(12) Patent Application Publication
(10) Pub. No.: US 2007/0024828 A1
(43) Pub. Date: Feb. 1, 2007

(54) Projector

(75) Inventors: Long-Sheng Liao, Hsinchu (TW); Sung-Nan Chen, Hsinchu (TW); Yi-Hsueh Chen, Hsinchu (TW)

Correspondence Address: BIRCH STEWART KOLASCH & BIRCH, PO BOX 747, FALLS CHURCH, VA, 22040-0747, US

(73) Assignee: Young Optics Inc.

(21) Appl. No.: 11/491,155

(22) Filed: Jul. 24, 2006

(30) Foreign Application Priority Data
Jul. 29, 2005 (TW) 94125841

(51) Int. Cl. G03B 21/00

(52) U.S. Cl. 353/122

(57) ABSTRACT

The present invention provides a projector utilizing two projecting light beams to enhance the resolutions thereof and comprises a light source, a light valve, an ultrasonic medium, a piezoelectric material, and a high-frequency oscillator. The light source device is used for generating light beams to project onto the light valve to form imaging light beams. The ultrasonic medium is passed through the imaging light beams with an incident angle, the piezoelectric material is disposed on one end of the ultrasonic medium, and the high-frequency oscillator electrically connects to the piezoelectric material for generating ultrasonic waves. The ultrasonic waves from the piezoelectric material are delivered to the ultrasonic medium and the imaging light beams pass through the ultrasonic medium to form a diffraction light beam along a first direction and a transmission light beam along a second direction are produced in order to increase resolution of images projected from the projector.

### FIELD OF THE INVENTION

The present invention relates to a projector, more particular to a projector utilizing two projecting light beams to enhance resolutions of images thereof.

### BACKGROUND OF THE INVENTION

Utilizing two projecting light beams is a cost saving mode of a conventional projector to achieve images with high resolution by means of a light valve with low resolution.

FIG. 1 illustrates a schematic view of a conventional projector generating two projecting light beams. A conventional projector 10 has a light source device 11, a lens 12, a light valve 13, a flat mirror 14, an oscillating device 15, a controlling device 17, and a focusing projection lens 18. A light beam generated from the light source device 11 passes through the lens 12 and then is projected into the light valve 13.

The light beam is projected into the light valve 13 to form an imaging light beam. The oscillating device 15 makes the flat mirror 14 have a swing motion and the imaging light beam passes the flat mirror 14 and separates to two different paths, for example projecting light beams 16 and 16′. The projecting light beams 16 and 16′ pass through the focusing projection lens 18 to project images with two times resolution of the images projected by the imaging light beam onto a screen 19 for enhancing the resolution of the images.

Additionally, the controlling device 17 is a controlling center to cooperate the light valve 13 and the oscillating device 15. Then the oscillating device 15 drives the flat mirror 14 to swing accordingly. Hence basic pixels of the images are in appropriate positions.

FIG. 2A illustrates a schematic views of pixel of an image from the projecting light beam 16 in FIG. 1. FIG. 2B illustrate a schematic views of pixel of an image from the projecting light beam 16′ in FIG. 1. FIG. 3 illustrates a schematic view of an overlapped image of the two images in FIGS. 2A and 2B.

As shown in FIG. 2A and FIG. 2B, the projecting light beams 16 and 16′ individually generate an image 21 and an image 22. Taking numbers of 0, 1, 2, and 3 represents four colors of basic pixels 23 including dark, red, green, and blue. Referring to FIG. 3, the images 21 and 22 are continuously and alternatively projecting onto the screen 19. The images 21 and 22 are overlapped to result in a two times resolution image due to an effect of photogene onto the screen 19.

However, the conventional projector still has some drawbacks listed below:

1. A lifetime of the oscillating device 15 is limited, especially comprising a motor.

2. Noise always products from the oscillating device 15.

3. A swinging period of the flat mirror 14 is longer than 1 millisecond (ms) generally to cause unstable images.

4. External conditions easily affect the conventional projector.

### SUMMARY OF THE INVENTION

The primary objective of the present invention is to provide a projector utilizing two projecting light beams so as to enhance resolutions of images thereof. Hence, number of elements of the projector is decreased and lifetime of the elements of the projector is increased.

The present invention provides a projector utilizing two projecting light beams to enhance resolutions of images thereof. The projector comprises a light source, a light valve, an ultrasonic medium, a piezoelectric material, and a high-frequency oscillator. The light source device is used for generating light beams. One of the light beams generated from the light source is projected onto the light valve. The light valve is used for receiving one of the light beams to form an imaging light beam. The ultrasonic medium is disposed on an optical transmission of the imaging light beam. The imaging light beam enters the ultrasonic medium with an incident angle and then is exited the ultrasonic medium with an emergence angle. The piezoelectric material is disposed on one end of the ultrasonic medium, and the high-frequency oscillator electrically connects to the piezoelectric material for generating ultrasonic waves. The ultrasonic waves from the piezoelectric material are delivered to the ultrasonic medium. Then the imaging light beam is exited the ultrasonic medium with ultrasonic waves to form two projecting light beams, such as a diffraction light beam along a first direction and a transmission light beam along a second direction alternatively due to Bragg's diffraction phenomenon in order to increase the resolution of the images of the projector.

In this way, that the number of elements of the projector is decreased and lifetime of the elements of the projector is increased.

### BRIEF DESCRIPTION OF THE DRAWINGS

The foregoing aspects and many of the attendant advantages of this invention will become more readily appreciated as the same becomes better understood by reference to the following detailed description.

FIG. 1 illustrates a schematic view of a conventional projector generating two projecting light beams.

FIG. 2A illustrates a schematic views of pixel of an image from the projecting light beam 16 in FIG. 1.

FIG. 2B illustrate a schematic views of pixel of an image from the projecting light beam 16′ in FIG. 1.

FIG. 3 illustrates a schematic view of an overlapped image of the two images in FIGS. 2A and 2B.

FIG. 4 illustrates a schematic view of a projector 30 according to a preferred embodiment of the present invention.

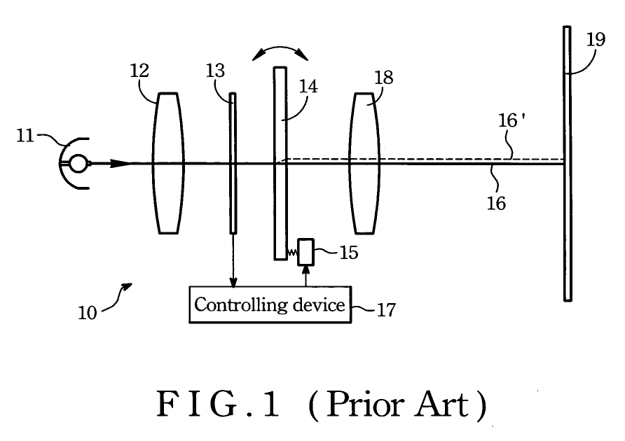

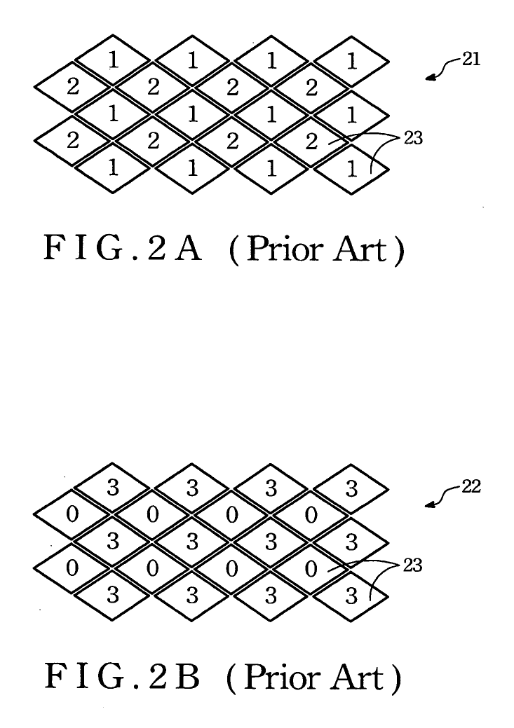

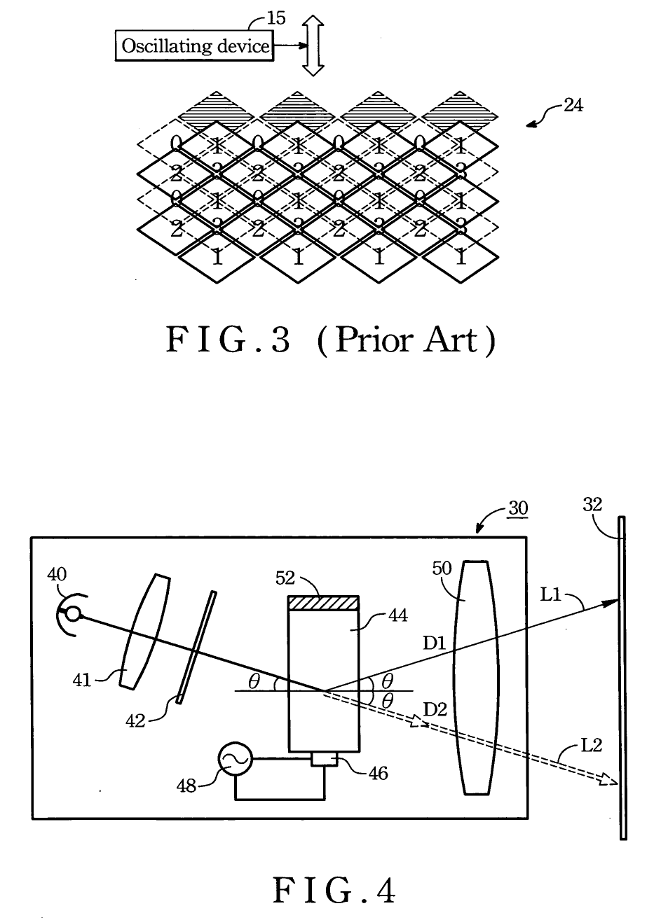

### DETAILED DESCRIPTION OF THE PREFERRED EMBODIMENTS

FIG. 4 illustrates a schematic view of a projector 30 according to a preferred embodiment of the present invention. Referring to FIG. 4, the projector 30 comprises a light source device 40, a lens 41, a light valve 42, an ultrasonic medium 44, a piezoelectric material 46, a high-frequency oscillator 48, and a zooming projection lens 50. The material of the ultrasonic medium 44 is selected from a group consisted of quartz, telluride glass, dense flint glass, PbMoO₄, TeO₃, and LiNbO₃.

The light source device 40 is used for generating light beams. One of the light beams passes through the lens 41 to be projected onto the light valve 42 so as to form an imaging light beam.

The light valve 42 comprises a reflective type light valve or a transmissive type light valve. The light valve 42 is a transmissive type light valve in the preferred embodiment of the present invention.

The ultrasonic medium 44 is disposed on an optical transmission of the imaging light beam. The imaging light beams from the light valve 42 enter the ultrasonic medium 44 with an incident angle θ and then are exited the ultrasonic medium 44 with an emergence angle θ. The piezoelectric material 46 is disposed on one end of the ultrasonic medium 44, and the high-frequency oscillator 48 electrically connects to the piezoelectric material 46 for generating ultrasonic waves.

The ultrasonic waves from the piezoelectric material 46 are delivered to the ultrasonic medium 44. Then the imaging light beams from the light valve 42 are exited the ultrasonic medium 44 with ultrasonic waves to form two projecting light beams, such as a diffraction light beam L1 along a first direction D1 and a transmission light beam L2 along a second direction D2 in order to increase resolutions of the images overlapped by the diffraction light beam L1 and the transmission light beam L2.

The two projecting light beams L1 and L2 are passed the zooming projection lens 50 to project the overlapped images onto a screen 32.

In another preferred embodiment, the projector 30 further has a sound-absorption material 52 disposed on one end of the ultrasonic medium 44 opposite to the end of the ultrasonic medium 44 disposed with the piezoelectric material 46. The sound-absorption material 52 absorbing the ultrasonic waves passed the ultrasonic medium 44 avoids that the ultrasonic waves interferes with other elements of the projector 30.

An angle between the diffraction light beam L1 and the transmission light beam L2 is defined as 2θ, a midline of the 2θ angle is a normal without considering refraction factors from the ultrasonic medium 44. In this way, the transmission light beam L2 is one of the imaging light beams extended from the light valve 42. An angle between the transmission light beam L2 and the normal is defined as θ, and an angle between the diffraction light beam L1 and the normal is defined as θ as well.

Assuming a wavelength of one of the imaging light beams from the light valve 42 is defined as λ, a wavelength of the ultrasonic wave is defined as λs, and a frequency of the ultrasonic wave is defined as f. A transmission velocity of the ultrasonic wave passing the ultrasonic medium is defined as Vs, a specific refraction value is defined as Δn according to a material character of the ultrasonic medium, and a length of the imaging light beam passing through the ultrasonic medium 44 is defined as L. While satisfying a condition of 2λs Sin θ=λ, the diffraction light beam L1 and the transmission light beam L2 are generated in accordance with Bragg's Law. Moreover, while satisfying a condition of 2θ=λ f/Vs, the ultrasonic wave is capable of regulating the suitable incident angle θ and controlling the directions of the diffraction light beam L1 and the transmission light beam L2.

Additionally, a strongest diffraction is happened to cause the length L control an optimized color of the diffraction light beam according to the suitable wavelength λ while satisfying a condition of Δn=λ/4L.

As a conclusion, the present invention adopts the piezoelectric material 46 to produce the ultrasonic waves. The imaging light beam exited the ultrasonic medium 44 is divided into two light beams of the diffraction light beam L1 and the transmission light beam L2 so as to increase the resolutions of the image projected from the projector 30. In this way, number of elements of the projector 30 is decreased, and lifetime of the elements of the projector 30 is increased.

While the present invention has been particularly shown and described with reference to a preferred embodiment, it will be understood by those skilled in the art that various changes in form and detail may be without departing from the spirit and scope of the present invention.

What is claimed is:

1. A projector comprising:
a light source for generating light beams;
a light valve for receiving the light beams to form imaging light beams;
an ultrasonic medium, disposed on an optical transmission of the imaging light beams;
a piezoelectric material disposed on one end of the ultrasonic medium; and
a high-frequency oscillator electrically connecting to the piezoelectric material for generating ultrasonic waves;
wherein each of the imaging light beams enters the ultrasonic medium with an incident angle and then is exited the ultrasonic medium with an emergence angle, the ultrasonic waves from the piezoelectric material are delivered to the ultrasonic medium to make the imaging light beam to form a diffraction light beam along a first direction and a transmission light beam along a second direction alternatively.

2. The projector of claim 1 further comprising a zooming projection lens, wherein the diffraction and the transmission light beams are passed through the zooming projection lens to project images onto a screen.

3. The projector of claim 1 further comprising a sound-absorption material disposed on one end of the ultrasonic medium opposite to the end of the ultrasonic medium disposed with the piezoelectric material.

4. The projector of claim 1, wherein the material of the ultrasonic medium is selected from a group consisted of quartz, telluride glass, dense flint glass, PbMoO₄, TeO₃, and LiNbO₃.

5. The projector of claim 1, wherein the incident angle is defined as θ, a wavelength of the imaging light beam is defined as λ, and a wavelength of the ultrasonic wave is defined as λs, while satisfying a condition of 2λs Sin θ=λ, the diffraction light beam and the transmission light beam are generated in accordance with Bragg's Law.

6. The projector of claim 5, further satisfying a condition of 2θ=λ f/Vs, wherein an angle between the diffraction light beam and the transmission light beam is defined as 2θ, a frequency of the ultrasonic wave is defined as f, and a transmission velocity of the ultrasonic wave passing the ultrasonic medium is defined as Vs.

7. The projector of claim 5, further satisfying a condition of Δn=λ/4L, wherein a refraction value of the ultrasonic medium is defined as Δn and the length of the imaging light beam passing through the ultrasonic medium is defined as L.
